(19) United States
(12) Patent Application Publication
(10) Pub. No.: US 2015/0222101 A1
(43) Pub. Date: Aug. 6, 2015

(54) WIRE HARNESS, WIRE HARNESS MANUFACTURING METHOD AND PROTECTIVE MEMBER

(71) Applicant: SUMITOMO WIRING SYSTEMS, LTD., Mie (JP)

(72) Inventor: Yasuhiro Kajiwara, Mie (JP)

(73) Assignee: SUMITOMO WIRING SYSTEMS, LTD., Mie (JP)

(21) Appl. No.: 14/429,544

(22) PCT Filed: Jun. 25, 2013
(86) PCT No.: PCT/JP2013/067301

§ 371 Date: Mar. 19, 2015

(30) Foreign Application Priority Data
Sep. 26, 2012 (JP) 2012-212216

(51) Int. Cl. H02G 3/04; H01B 7/00

(52) U.S. Cl. CPC H02G 3/0406; H01B 7/0045

(57) ABSTRACT

The present invention is provided to inhibit contact noise between a protective member and a member in a vicinity thereof. A wire harness is provided with a wire harness body that includes at least one wire, and a protective member. The protective member includes: a protective body that is formed from a non-fibrous material into a shape that covers at least a portion of the wire harness body; and a nonwoven member that is bonded to at least one main surface of the protective body.

### FIELD OF THE INVENTION

The invention relates to a technology that protects a wire harness.

### BACKGROUND OF THE INVENTION

Conventionally, as disclosed in Patent Literature 1, a technology is known in which a wire harness is protected using a protector that is formed by resin molding.

### RELATED ART Patent Literature

Patent Literature 1: Japanese Patent Laid-Open Publication No. 2012-105495.

### SUMMARY OF THE INVENTION

### Problems to be Solved by the Invention

However, in the case of the protector formed by resin molding, when the protector is in contact with a member in a vicinity thereof, a contact noise is generated.

Therefore, a purpose of the invention is to suppress a contact noise between a protective member and a member in a vicinity thereof.

### Means for Solving the Problems

In order to achieve the above purpose, a wire harness according to a first aspect of the invention includes: a wire harness body that includes at least one wire; and a protective member that includes a protective body that is formed from a non-fibrous material into a shape that covers at least a portion of the wire harness body, and a nonwoven member that is bonded to at least one main surface of the protective body.

According to a second aspect to the invention, in the wire harness according to the first aspect of the invention, the protective body is formed from a non-fibrous resin material.

According to a third aspect to the invention, in the wire harness according to any one of the first and second aspects of the invention, the nonwoven member contains a binder, and the nonwoven member is bonded via the binder to the protective body.

According to a fourth aspect to the invention, in the wire harness according to any one of the first—third aspects of the invention, the nonwoven member is superimposed on two main surfaces of the protective body.

According to a fifth aspect to the invention, in the wire harness according to the fourth aspect of the invention, holes that penetrate through the two main surfaces of the protective body are formed on the protective body.

According to a sixth aspect to the invention, in the wire harness according to any one of the fourth and fifth aspects of the invention, the protective body is formed in a net-like shape.

According to a seventh aspect to the invention, in the wire harness according to any one of the first—fourth aspects of the invention, the protective body is formed in a shape of a plate having no holes formed thereon.

A wire harness manufacturing method according to an eighth aspect to the invention includes: (a) preparing a protective body that is formed from a non-fibrous material into a shape that covers at least a portion of a wire harness body; (b) superimposing a nonwoven member on at least one main surface of the protective body; (c) forming a protective member by applying heat and pressure to the protective body and the nonwoven member that are superimposed and bonding the protective body and the nonwoven member to each other; and (d) accommodating at least a portion of the wire harness body inside the protective member.

A wire harness manufacturing method according to a ninth aspect to the invention includes: (e) superimposing a nonwoven member on at least one main surface of a flat plate-shaped member that is formed from a non-fibrous material; (f) forming a protective member by applying heat and pressure to the flat plate-shaped member and the nonwoven member that are superimposed and bonding the flat plate-shaped member and the nonwoven member while processing the flat plate-shaped member into a shape that covers at least a portion of a wire harness body; and (g) accommodating at least a portion of the wire harness body inside the protective member.

A protective member according to a tenth aspect to the invention includes: a protective body that is formed from a non-fibrous material into a shape that covers at least a portion of a wire harness body; and a nonwoven member that is bonded to at least one main surface of the protective body.

### Effect of the Invention

According to the first, eighth—tenth aspects of the invention, due to the protective body, protection and path regulation of the wire harness body can be sufficiently performed. Further, due to the nonwoven member that is bonded to at least one main surface of the protective body, a contact noise between the protective member and a neighboring part thereof can be suppressed.

According to the second aspect of the invention, protection and path regulation of the wire harness body can be sufficiently performed while the protective body can be made light-weight.

According to the third aspect of the invention, bonding of the nonwoven member to the protective body can be easily performed.

According to the fourth aspect of the invention, a contact noise between the protective member and the wire harness body inside the protective member can be suppressed, and a contact noise between the protective member and a peripheral member thereof outside the protective member can be suppressed.

According to the fifth aspect of the invention, the nonwoven members on the two main surfaces of the protective body can be bonded to each other by being in contact with each other. Therefore, the nonwoven members are unlikely to be detached from the protective body.

According to the sixth aspect of the invention, the nonwoven members on the two main surfaces of the protective body can be bonded to each other by being in contact with each other at a large number of places through meshes. Therefore, the nonwoven members are even more unlikely to be detached from the protective body.

According to the seventh aspect of the invention, the protective body is formed in a plate-like shape and thus can more firmly protect the wire harness body.

According to the eighth aspect of the invention, a robust protective body can be easily manufactured. As a result, protection and path regulation of the wire harness body can be sufficiently performed.

According to the ninth aspect of the invention, processing the flat plate-shaped member into a shape that covers at least a portion of the wire harness body and bonding the flat plate-shaped member and the nonwoven member can be simultaneously performed. Therefore, the protective member can be easily manufactured.

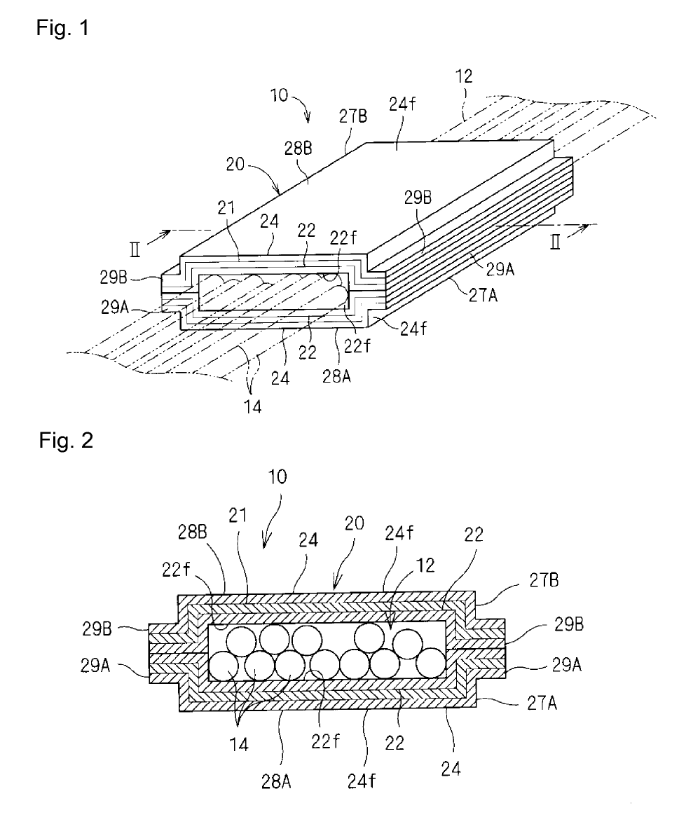

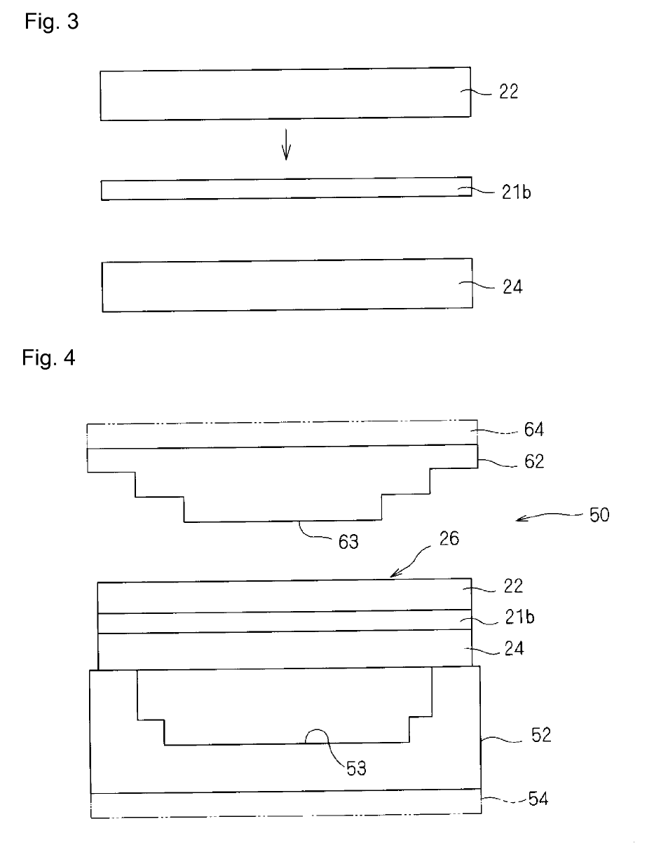

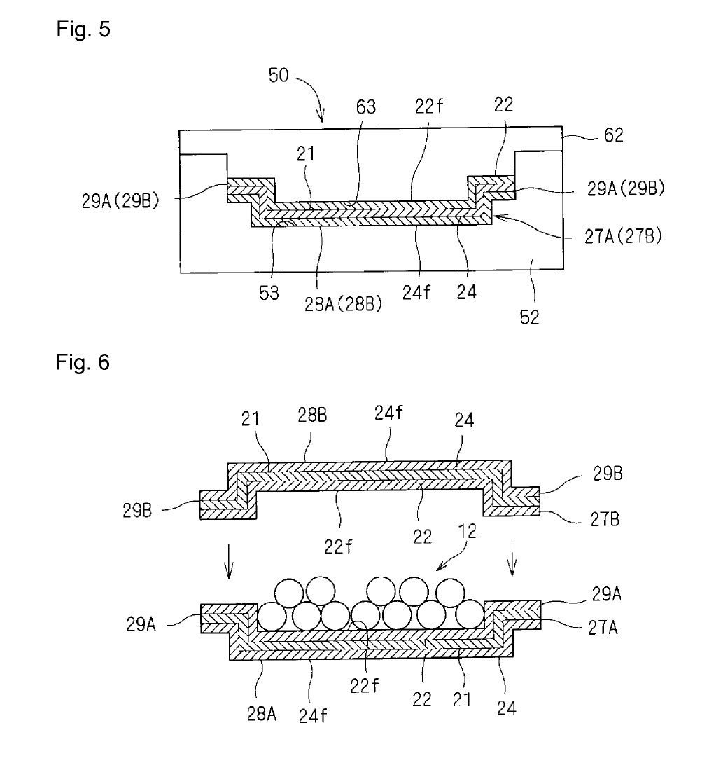

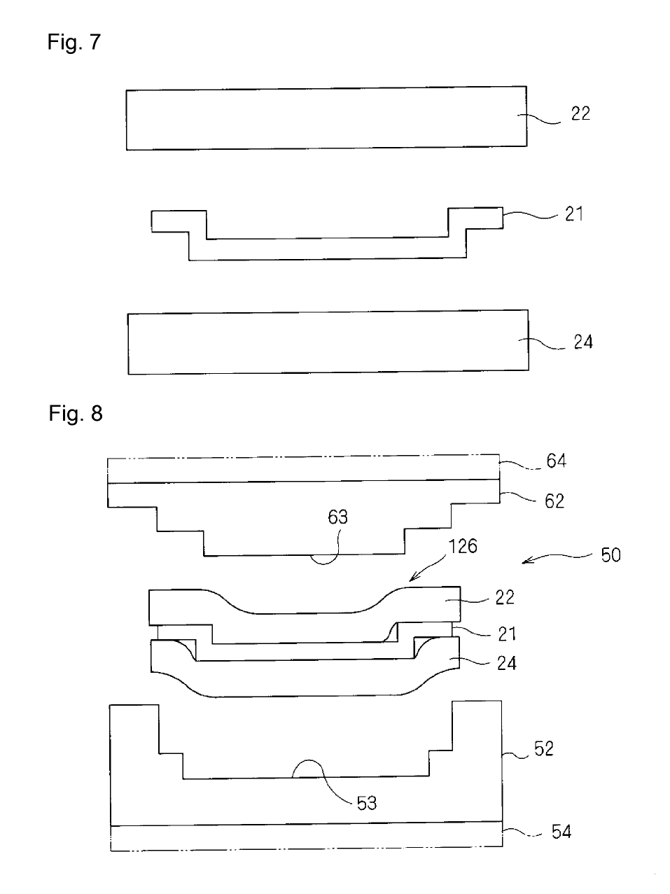

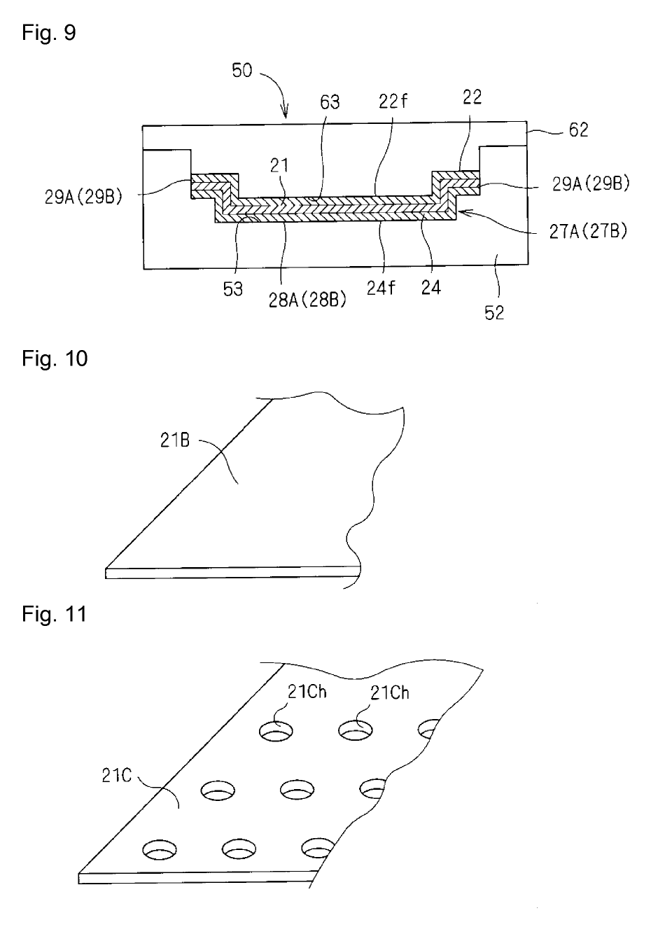

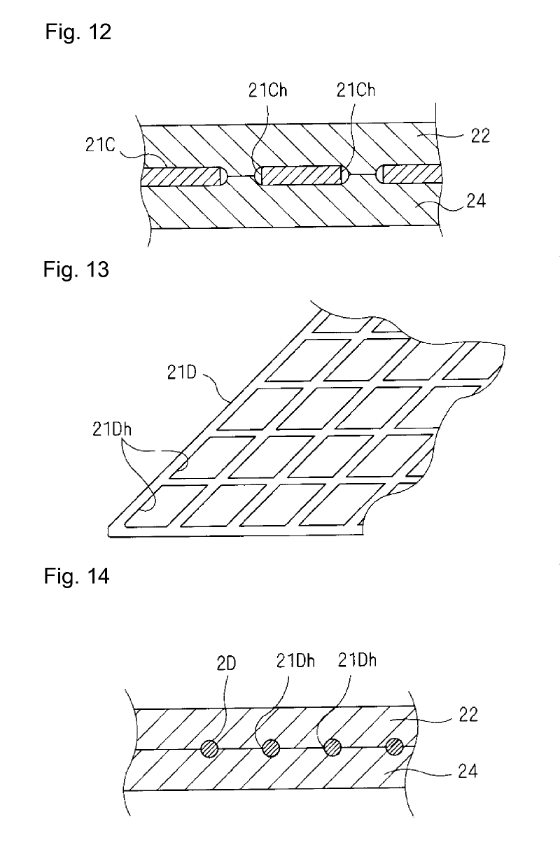

### BRIEF DESCRIPTION OF DRAWINGS

[FIG. 1] illustrates a perspective view of a wire harness 10 according to an embodiment.

[FIG. 2] illustrates a cross-sectional view along a line II-II of FIG. 1.

[FIG. 3] illustrates an explanatory diagram illustrating a process according to an example of a manufacturing method of the wire harness.

[FIG. 4] illustrates an explanatory diagram illustrating a process according to the example of the manufacturing method of the wire harness.

[FIG. 5] illustrates an explanatory diagram illustrating a process according to the example of the manufacturing method of the wire harness.

[FIG. 6] illustrates an explanatory diagram illustrating a process according to the example of the manufacturing method of the wire harness.

[FIG. 7] illustrates an explanatory diagram illustrating a process according to another example of the manufacturing method of the wire harness.

[FIG. 8] illustrates an explanatory diagram illustrating a process according to the other example of the manufacturing method of the wire harness.

[FIG. 9] illustrates an explanatory diagram illustrating a process according to the other example of the manufacturing method of the wire harness.

[FIG. 10] illustrates an explanatory diagram illustrating an example of a protective body.

[FIG. 11] illustrates an explanatory diagram illustrating another example of the protective body.

[FIG. 12] illustrates an explanatory diagram illustrating the other example of the protective body.

[FIG. 13] illustrates an explanatory diagram illustrating yet another example of the protective body.

[FIG. 14] illustrates an explanatory diagram illustrating the yet another example of the protective body.

### MODE FOR CARRYING OUT THE INVENTION

In the following, a wire harness, a wire harness manufacturing method and a protective member according to an embodiment are described.

FIG. 1 illustrates a perspective view of a wire harness 10. FIG. 2 illustrates a cross-sectional view along a line II-II of FIG. 1.

The wire harness 10 includes a wire harness body 12 and a protective member 20.

The wire harness body 12 includes at least one wire 14. Here, the wire harness body 12 includes a portion in which a plurality of wires 14 are bundled. This portion is protected by the protective member 20. The wire harness body 12 may be branched along the way. The wire harness body 12 may also include an optical fiber cable and the like. The entire wire harness body may be protected by a protective member.

The wire harness body 12 is connected to various on-vehicle electronic components via connector connections and the like in a state of being arranged along a predetermined wiring form in a vehicle. As a result, the on-vehicle electronic components are mutually electronically connected via the wire harness body 12.

The protective member 20 is formed in a tubular shape, more specifically, in a flat rectangular tubular shape, as a shape covering at least a portion of the wire harness body 12. Here, a protective body 21 linearly extends. However, the protective body 21 may also bend along the way, and may also branch along the way.

Further, the protective member 20 is configured by a combination of a plurality of split protective bodies 27A, 27B. More specifically, the protective member 20 includes a pair of the split protective bodies 27A, 27B that are obtained by splitting the protective member 20 into two on the short sides of the flat rectangular tubular shape thereof. Further, the pair of the split protective bodies 27A, 27B may be separately formed or may be openably and closably linked to each other via a hinge or the like. Here, an example is described in which the pair of the split protective bodies 27A, 27B are separately formed.

The split protective bodies 27A, 27B respectively include accommodating bodies 28A, 28B and edges 29A, 29B.

The accommodating bodies 28A, 28B are each formed in a semi-tubular shape, here, a rectangular semi-tubular shape, more specifically, a flat rectangular semi-tubular shape, corresponding to a wiring path of a to-be-protected portion of the wire harness body 12. In each of the accommodating bodies 28A, 28B, a shallow accommodating recess is formed. The accommodating recess opens on two ends of the accommodating bodies 28A, 28B and opens toward one side between the two ends.

The edges 29A, 29B are formed projecting outward on both sides of the accommodating bodies 28A, 28B. The edges 29A, 29B are formed in long and thin plate-like shapes extending along a direction connecting edges on two sides of the accommodating bodies 28A, 28B.

In a state in which the to-be-protected portion of the wire harness body 12 is accommodated between the pair of the split protective bodies 27A, 27B, when portions on both sides of the pair of the split protective bodies 27A, 27B are caused to butt against each other, the edges 29A, 29B butt against each other and are bonded in a state of being in surface contact with each other. As a result, the protective member 20 protecting at least a portion of the wire harness body 12 is configured. The bonding of the edges 29A, 29B with each other can be performed using a double-sided tape, ultrasonic bonding, thermal welding, a stapler, and the like.

Here, it is not necessary that the pair of the split protective bodies 27A, 27B are formed in plane symmetrical shapes with respect to their bonding surfaces. For example, one of the pair of the split protective bodies may be formed in a shape having a depth deeper than the other. Further, one of the split protective bodies may be formed in a flat plate-like shape. Still, it is preferable that edges of the pair of the split protective bodies on both sides oppose each other at as many places as possible.

The split protective bodies 27A, 27B each include a protective body 21 and nonwoven members 22, 24 that are bonded to at least one of main surfaces of the protective body 21.

The protective body 21 is formed from a non-fibrous material into a shape that covers at least a portion of the wire harness body 12.

Here, the non-fibrous material means that a material that forms a basic form is not a fiber; that is, the material is not a nonwoven fabric that is obtained by bonding or intertwining fibers or a cloth that is obtained by weaving fiber-twisted yarns. As such a non-fibrous material, a resin material of a densely compacted resin forming a predetermined shape, a metal material, or the like, can be assumed.

It is preferable that the protective body 21 be formed from a non-fibrous resin material. The non-fibrous resin material means that a material that forms a basic form is not a resin fiber; that is, the material is not a resin nonwoven fabric that is obtained by bonding or intertwining resin fibers or a resin cloth that is obtained by weaving fiber-twisted yarns; that is, the material is a resin material of a densely compacted resin forming a predetermined shape. The protective body 21 may be preferably formed from, for example, polypropylene (PP) and the like. Further, it is preferable that the protective body 21 be formed from a hard resin.

However, it is also possible that the protective body 21 does not contain any fiber, or contains fiber for an auxiliary purpose such as reinforcement and imparting conductivity.

Further, here, the protective member 20 as will be described later is configured by a combination of a plurality (here two) of the split protective bodies 27A, 27B, and each of the split protective bodies 27A, 27B includes the protective body 21.

Each of the protective bodies 21 is formed in a shape corresponding to the shape of the split protective bodies 27A, 27B, as a shape that covers one side of at least a portion of the wire harness body 12. That is, each of the protective bodies 21 is formed in a semi-tubular shape according to a wiring path of a to-be-protected portion of the wire harness body 12. More specifically, the protective body 21 is formed in a shape in which the edges are formed projecting outward on both sides of a rectangular semi-tubular portion in which the accommodating recess is formed. The protective body 21 maintains its own shape and thereby the above-described shape of each of the split protective bodies 27A, 27B is maintained.

Here, the nonwoven member 22 is bonded to an inner side main surface of the protective body 21 and the nonwoven member 24 is bonded to an outer side main surface of the protective body 21. The nonwoven members 22, 24 are configured by bonding or intertwining fibers and are flexible. Therefore, an inward surface 22f of the nonwoven member 22 on the inner side exhibits a flexible property on an inner surface of the protective member 20 (the split protective bodies 27A, 27B). Therefore, inside the protective member 20, even when the inner surface of the protective member 20 and the wire harness body 12 are in contact with each other, a contact noise is unlikely to occur. Further, an outward surface 24f of the nonwoven member 24 on the outer side exhibits a flexible property on an inner surface of the protective member 20 (the split protective bodies 27A, 27B). Therefore, even when a peripheral member of the wire harness 10 in a vehicle is in contact with the outer surface of the protective member 20, a contact noise between the outer surface of the protective member 20 and the peripheral member is unlikely to occur.

Although it is preferable that the nonwoven members 22, 24 cover the entire main surfaces of the protective body 21, it is not necessarily required. It is also possible that a portion of the main surfaces of the protective body 21 is exposed to outside.

It is preferable that the nonwoven members 22, 24 be formed from a material that can be bonded to the protective body 21 by applying heat and pressure to the protective body 21. As such nonwoven members 22, 24, a material containing a base fiber and a binder (also referred to as an adhesive resin) can be used. The binder is a resin having a melting point lower than a melting point of the base fiber. Then, by heating the nonwoven members to a temperature lower than the melting point of the base fiber and higher than the melting point of the binder, the binder melts and soaks into the base fiber. Then, when the temperature of the nonwoven members decreases after the molten binder reaches the protective body 21, the binder solidifies in a state of being in contact with the protective body 21. As a result, the nonwoven members 22, 24 and the protective body 21 are bonded to each other. Further, the base fiber maintains a fibrous state without being melted, and thereby a flexible state of the nonwoven members 22, 24 can be maintained.

As the base fiber of the nonwoven members, in addition to a resin fiber, various fibers such as a glass fiber can be used as far as the fibers can maintain a fibrous state at the melting point of the binder. Further, as the binder, a thermoplastic resin fiber having a melting point lower than the melting point of the base fiber can be used. For example, as a combination of a base fiber and a binder, a PET (polyethylene terephthalate) resin fiber can be adopted as the base fiber, and a copolymer resin of PET and PEI (polyethylene isophthalate) can be adopted as the binder.

In the case where a material containing a binder is used as the nonwoven members 22, 24, when the protective body 21 in a state of being sandwiched by the nonwoven members 22, 24 is heated and pressed, the nonwoven members 22, 24 can be bonded to the protective body 21.

In the case where a material that does not contain a binder is used as the nonwoven members 22, 24, the nonwoven members 22, 24 can be bonded to the protective body 21 by a double-sided tape, an adhesive, or the like.

However, using a material containing a binder as the nonwoven members 22, 24 allows an operation to paste a double-sided tape, an operation to apply an adhesive, or the like, to be omitted and allows the bonding operation to be easily performed. Further, there is an advantage that, by applying heat and pressure to an entire contact portion between the nonwoven members 22, 24 and the protective body 21, the entire nonwoven members 22, 24 can be easily bonded to the protective body 21.

Here, a state is illustrated in which the wires 14 that configure the wire harness body 12 are accommodated in an unbundled state between the pair of the split protective bodies 27A, 27B so as to fill therein. However, the wires 14 that configure the wire harness body 12 may also be bundled using a binder such as an adhesive tape.

The protective member 20 may also be configured by a combination of three split protective bodies.

According to the wire harness 10 and the protective member 20 that are configured as described above, due to the relatively rigid protective body 21, protection and path regulation of the wire harness body 12 can be sufficiently performed. Further, due to relatively flexible nonwoven members 22, 24 that are bonded to at least one main surface of the protective body 21, a contact noise between the protective member 20 and a neighboring part thereof, such as the internal wire harness body 12 or a vehicle peripheral member can be suppressed.

In particular, by bonding the nonwoven members 22, 24 to the two main surfaces of the protective member 20, a contact noise between the protective member 20 and the wire harness body 12 inside the protective member 20 can be suppressed, and a contact noise between the protective member 20 and a peripheral member thereof outside the protective member 20 can be suppressed.

The nonwoven members 22, 24 may have the same or different flexibilities.

Further, by forming the protective body 21 using a non-fibrous resin material, protection and path regulation of the wire harness body 12 can be sufficiently performed while the protective body 21 can be made light-weight.

An example of a manufacturing method of the above-described wire harness 10 is described.

First, as illustrated in FIG. 3, a plate material 21b as an original material for forming the protective body 21 is prepared. As the plate material 21b, a flat plate-shaped member that is deformable by pressure or by heat and pressure can be used. Here, an example is described in which, as the plate material 21b, a non-fibrous resin plate material is used. The nonwoven members 22, 24 are superimposed on at least one main surface of the plate material 21b. Here, the plate material 21b is sandwiched between the pair of the nonwoven members 22, 24. Here, the nonwoven members 22, 24 and the plate material 21b have the same size and shape, and the nonwoven members 22, 24 exist over the entire plate material 21b. However, this is not always necessary.

Next, as illustrated in FIGS. 4 and 5, a mold 50 is used to perform molding of the protective body 21 and bonding of the nonwoven members 22, 24.

The mold 50 includes a lower mold 52 and an upper mold 62.

The lower mold 52 is a long member that is formed of a metal and the like having excellent thermal conductivity. A lower mold surface 53 is formed on one main surface (upper surface) of the lower mold 52. The lower mold surface 53 is a portion that forms outer peripheral surfaces of the split protective bodies 27A, 27B and is formed in a groove shape that is deep at a center in a width direction and becomes shallow over a step at both sides in the width direction. A dimension of the lower mold surface 53 in a longitudinal direction is set to be the same as or longer than a length of a portion of the wire harness body 12 that is a to-be-protected portion. The lower mold surface 53 is formed in a shape that extends according to a path of the to-be-protected portion of the wire harness body 12 when the wire harness body 12 is arranged in a vehicle.

The upper mold 62 is a long member that is formed of a metal and the like having excellent thermal conductivity. An upper mold surface 63 is formed on one main surface (lower surface) of the upper mold 62. The upper mold surface 63 has a long and thin protruding shape and is formed in a shape that is high at a center in a width direction and becomes low over a step at both sides in the width direction. The upper mold surface 63 is configured to have a width that allows the upper mold surface 63 to be arranged inside the lower mold surface 53 while allowing the upper opening of the above lower mold surface 53 to be covered. Further, the upper mold surface 63 is formed in a shape that extends according to a shape of the above lower mold surface 53.

By arranging the upper mold surface 63 inside the lower mold surface 53, a space between the two is formed that allows the split protective bodies 27A, 27B to be formed. Heating parts 54, 64 such as heaters are respectively provided in the lower mold 52 and the upper mold 62.

A processing method using the above-described mold 50 is described.

First, a laminate 26 of the plate material 21b and the nonwoven members 22, 24 is arranged inside the lower mold surface 53. It is also possible to perform a lamination operation of the plate material 21b and the nonwoven members 22, 24 on the lower mold surface 53.

Thereafter, the upper mold surface 63 of the upper mold 62 is arranged inside the lower mold surface 53. The laminate 26 is sandwiched from both sides by the lower mold surface 53 and the upper mold surface 63, and heat and pressure are applied to the laminate 26. Then, the laminate 26 is heated around portions thereof that are in contact with the lower mold 52 and the upper mold 62. When heat is transmitted via the nonwoven members 22, 24 to the plate material 21b and the plate material 21b is softened, the plate material 21b deforms into a shape that is pressed between the lower mold surface 53 and the upper mold surface 63 via the nonwoven members 22, 24. Further, when a binder contained in the nonwoven members 22, 24 is melted by the heat, the molten binder soaks into base fiber and reaches surfaces of the protective body 21.

Thereafter, when the laminate 26 is cooled, the plate material 21b is cured, between the lower mold 52 and the upper mold 62, in a state of being processed into a shape of the above-described protective body 21 that is a shape covering at least a portion of the wire harness body 12. Further, the molten binder solidifies in a state in which the nonwoven members 22, 24 and the plate material 21b are bonded. As a result, the split protective bodies 27A, 27B that configure the protective member 20 are formed. In the present manufacturing method, as the plate material 21b, a material having a softening temperature lower than a softening temperature or a melting point of the base fiber of the nonwoven members 22, 24 is selected. Since the binder soaks into the nonwoven members 22, 24, the nonwoven members 22, 24 are also hardened to some extent. However, the nonwoven members 22, 24 are soft as compared to the protective body 21.

Thereafter, the split protective bodies 27A, 27B are taken out from the mold 50. The pair of the split protective bodies 27A, 27B may be formed using the same mold 50, or using separate hot press molds.

Then, as illustrated in FIG. 6, the pair of the split protective bodies 27A, 27B that are formed as described above are prepared, and when the pair of the split protective bodies 27A, 27B are integrated in a state in which at least a portion of the wire harness body 12 is accommodated inside the pair of the split protective bodies 27A, 27B, the wire harness 10 is manufactured.

As described above, the integration of the two can be performed by bonding the edges 29A, 29B that butt against each other, for example, using a double-sided tape.

According to this manufacturing method, it is possible to simultaneously perform processing the flat plate-shaped plate material 21 b into a shape covering at least a portion of the wire harness body 12 and bonding the protective body 21, which is formed from the flat plate-shaped plate material 21 b, and the nonwoven members 22, 24. Therefore, there is an advantage that the protective member 20 can be easily manufactured.

Another example of the manufacturing method of the above-described wire harness 10 is described.

First, a protective body 21 that is formed from a non-fibrous material into a shape that covers at least a portion of the wire harness body 12 is prepared. For example, a protective body 21 that is die-molded in advance by filling and cooling a molten resin in a resin mold is prepared.

Then, as illustrated in FIG. 7, the nonwoven members 22, 24 are superimposed on at least one of main surfaces of the protective body 21. Here, the protective body 21 is sandwiched between the pair of the nonwoven members 22, 24. Here, the nonwoven members 22, 24 cover the entire protective body 21. However, this is not always necessary.

Next, as illustrated in FIGS. 8 and 9, the same mold 50 as above is used to perform molding of the protective body 21 and bonding of the nonwoven members 22, 24.

That is, a laminate 126 of the protective body 21 and the nonwoven members 22, 24 is arranged inside the lower mold surface 53. It is also possible to perform a lamination operation of the plate material 21b and the nonwoven members 22, 24 on the lower mold surface 53.

Thereafter, the upper mold surface 63 of the upper mold 62 is arranged inside the lower mold surface 53. The laminate 126 is sandwiched from both sides by the lower mold surface 53 and the upper mold surface 63, and heat and pressure are applied to the laminate 126. Then, the laminate 26 is heated around portions thereof that are in contact with the lower mold 52 and the upper mold 62. Further, when a binder contained in the nonwoven members 22, 24 is melted by the heat, the molten binder soaks into base fiber and reaches surfaces of the protective body 21.

Thereafter, when the laminate 126 is cooled, the molten binder solidifies in a state in which the nonwoven members 22, 24 and the protective body 21 are bonded. As a result, the split protective bodies 27A, 27B that configure the protective member 20 are formed.

Thereafter, the split protective bodies 27A, 27B are taken out from the mold 50. The pair of the split protective bodies 27A, 27B may be formed using the same mold 50, or using separate hot press molds.

Then, similar to the above, when the pair of the split protective bodies 27A, 27B are integrated in a state in which at least a portion of the wire harness body 12 is accommodated inside the pair of the split protective bodies 27A, 27B, the wire harness 10 is manufactured.

According to this manufacturing method, as a material for forming the protective body 21, it is not necessary to use a material that is deformable inside the mold 50 by pressure or by heat and pressure. Therefore, a robust protective body 21 can be easily manufactured. As a result, protection and path regulation of the wire harness body 12 can be sufficiently performed.

{Modified Embodiment}

The protective body 21 may have any shape as far as the protective body 21 can maintain a shape that covers at least a portion of the wire harness body 12.

As illustrated in FIG. 10, a protective body 21 B may be formed in a shape of a plate having no holes thereon.

In this case, the entire portion of the wire harness body 12 that is covered by the protective member 20 can be covered and protected by the protective body 21. Therefore, protection performance, in particular, wear resistance, of the wire harness body 12 is superior.

Further, as illustrated in FIG. 11, on a protective body 21C, holes 21Ch may be formed that penetrate through two main surfaces of the protective body 21C.

When the holes 21Ch are formed on the protective body 21C, as illustrated in FIG. 12, the nonwoven members 22, 24 that are bonded to the two surfaces of the protective body 21C can be bonded to each other in a state of being in contact with each other through the holes 21Ch. Therefore, the nonwoven members 22, 24 are unlikely to be detached from the protective body 21C. In particular, when bonding using the binder of the nonwoven members 22, 24 is considered, it is believed that bonding the nonwoven members 22, 24 to each other using the binder of both of the nonwoven members 22, 24 is superior in bonding strength as compared to bonding the nonwoven members 22, 24 to the smooth surfaces of the protective body 21C.

When ensuring a certain degree of strength of the protective body 21C is considered, it is preferable that the holes 21Ch that are formed on the protective body 21C be scattered at certain intervals (for example, at intervals equal to or greater than a diameter of the holes 21Ch).

Further, as illustrated in FIG. 13, a protective body 21D may be formed in a net-like shape.

In this case, as illustrated in FIG. 14, the nonwoven members 22, 24 that are bonded to the two surfaces of the protective body 21D can be bonded to each other in a state of being in contact with each other through a large number of meshes 21Dh. Therefore, the nonwoven members 22, 24 are even more unlikely to be detached from the protective body 21C.

The configurations described in the above embodiment and modified embodiments can be combined as appropriate as far as they do not contradict each other.

In the above, the invention is described in detail. However, the above description in all aspects is for exemplary purposes and the invention is not limited by the description. Numerous modified embodiments that are not exemplified can be envisioned without departing from the scope of the invention.

### DESCRIPTION OF REFERENCE NUMERALS

10 Wire harness

12 Wire harness body

14 wire

20 protective member

21, 22B, 21C, 21D protective body

21b plate material

21Ch hole

21Dh meshes

22, 24 nonwoven member

26, 126 laminate

1. A wire harness comprising:
a wire harness body that includes at least one wire; and
a protective member that is configured by a combination of a plurality of split protective bodies that each include
a protective body that is formed from a non-fibrous material into a shape that covers at least a portion of the wire harness body, and
a nonwoven member that is bonded to at least one main surface of the protective body, wherein
the plurality of the split protective bodies are combined in a condition in which at least a portion of the wire harness body is accommodated between the plurality of the split protective bodies.

2. The wire harness according to claim 1, wherein
the protective body is formed from a non-fibrous resin material.

3. The wire harness according to claim 1, wherein
the nonwoven member contains a binder, and
the nonwoven member is bonded via the binder to the protective body.

4. (canceled)

5. The wire harness according to claim 1, wherein
holes that penetrate through the two main surfaces of the protective body are formed on the protective body.

6. The wire harness according to claim 1, wherein
the protective body is formed in a net-like shape.

7. The wire harness according to claim 1, wherein
the protective body is formed in a shape of a plate having no holes.

8. A wire harness manufacturing method comprising:
(a) preparing a protective body that is formed from a non-fibrous material into a shape that covers at least a portion of a wire harness body;
(b) superimposing a nonwoven member on two main surfaces of the protective body;
(c) forming split protective bodies by applying heat and pressure to the protective body and the nonwoven member that are superimposed and bonding the protective body and the nonwoven member to each other; and
(d) configuring a protective member by combining a plurality of the split protective bodies so that at least a portion of the wire harness body is accommodated between the plurality of the split protective bodies, and accommodating at least a portion of the wire harness body inside the protective member.

9. A wire harness manufacturing method comprising:
(e) superimposing a nonwoven member on two main surfaces of a flat plate-shaped member that is formed from a non-fibrous material;
(f) forming a split protective body by applying heat and pressure to the flat plate-shaped member and the nonwoven member that are superimposed and bonding the flat plate-shaped member and the nonwoven member while processing the flat plate-shaped member into a shape that covers at least a portion of a wire harness body; and
(g) configuring a protective member by combining a plurality of the split protective bodies so that at least a portion of the wire harness body is accommodated between the plurality of the split protective bodies, and accommodating at least a portion of the wire harness body inside the protective member.

10. A protective member that is configured by combining a plurality of the split protective bodies, each of the plurality of the split protective bodies comprising:
a protective body that is formed from a non-fibrous material into a shape that covers at least a portion of a wire harness body; and
a nonwoven member that is bonded to two main surfaces of the protective body.
